(19) United States
(12) Patent Application Publication
(10) Pub. No.: US 2012/0186021 A1
(43) Pub. Date: Jul. 26, 2012

(54) DISMOUNTABLE STRETCHER TO BE USED DURING SALVAGE OPERATIONS IN IMPASSABLE ZONES

(75) Inventor: Federico Bonomelli, Dolzago (LC) (IT)

(73) Assignee: MAKO SHARK S.R.L., Dolzago (LC) (IT)

(21) Appl. No.: 13/384,623

(22) PCT Filed: Jun. 30, 2010
(86) PCT No.: PCT/IB2010/052994

§ 371 Date: Apr. 12, 2012

(30) Foreign Application Priority Data
Jul. 22, 2009 (IT) MI2009A001303

(51) Int. Cl. A61G 1/013; A61G 1/048; A61G 1/007; A61G 1/044

(52) U.S. Cl. 5/627

(57) ABSTRACT

A stretcher, suitable for carrying out rescue of injured persons in not easily accessible areas, such as speleologists trapped in caves, people in difficulty in the mountains, people to be rescued from the water, also with the intervention of helicopters, includes a rigid board, which can easily be dismantled and reassembled without tools, the rigid part including elements that slot together to form the rigid board, designed to support the weight of the person to be carried, and is characterized in that it envisages at least one element that develops basically in a direction parallel to the longitudinal axis of the board and connects up directly to the other elements constituting the board, there being provided first members designed to prevent relative movements between the elements constituting the board, out of the plane of the board, and second members designed to prevent any relative sliding between the elements.

The present invention relates to a stretcher that can be dismantled, suitable for carrying out rescue of injured persons in impracticable or not easily accessible areas, as in the case of speleologists trapped in caves, people in difficulty in the mountains in summer or in winter, people to be rescued from the water, also with the intervention of helicopters.

The stretcher according to the invention comprises a rigid part, or board, which can be easily dismantled and reassembled without the use of tools, and a flexible part, such as protective sheets and straps or belts, according to the specific type of rescue operation to be carried out. The invention is completed by a series of accessories that, applied to the rigid part, enable stretchers to be obtained suitable for rescue on snow, in water, and with the use of helicopters.

Rescue of speleologists trapped in caves is performed by means of a stretcher that comprises a flexible container, which is wound around the injured person so as to cover him completely, in order to protect him from inevitable impact and rubbing against the walls of the cave. For the person to have an adequate support, the equipment envisages a sort of envelope, arranged in the direction of the length, inserted in which is a rigid board designed to support the weight of the injured person. Once this operation has been performed, the whole arrangement is closed with straps that secure the injured person to the stretcher so that he cannot fall out, whatever the position he assumes during the rescue operation.

The rigid board is preferably made up of a number of parts that can be assembled together so that they can be rapidly transported to the place where the injured person is located. While first aid is being carried out and the injured person is being harnessed to the stretcher, other persons will possibly see to widening the passageways for return to the surface.

In accordance with a first solution according to the known art, the rigid board can be made up of a series of metal tubular elements that, by means of appropriate elements, slot together so as to form a rigid surface.

In accordance with a second solution of the known art, the rigid board is made up of two half-boards hinged together so as to be foldable on one another in order to halve the length. Boards of this type can be made of composite material, preferably of carbon fibre.

A rigid board of the first type presents the advantage, when dismantled, of fitting into a small bag, which is easily transportable. However, it is extremely awkward to assemble, above all in the particular situations in which it is used. Furthermore, it is not particularly rigid and, being made of metal, is not transparent to x-rays. This is a drawback of some importance because it makes it impossible to lay the injured person out on the x-ray table in the hospital as soon as he arrives. It is in fact necessary to remove the person from the harness, lay him on a bed and, from here, transfer him onto the x-ray table. These operations could prove difficult and particularly painful for the injured person if he were to have serious fractures.

The aforesaid drawbacks are overcome by the boards of the second type, which are transparent to x-rays. However, there remain two serious drawbacks.

In the first place, a foldable board, which, for transport, simply halves its length, has transverse dimensions that are still too large, and hence such as to cause some problems in transport.

In the second place, the opening of the board, obtained via rotation of a part thereof around the hinge, could give rise to a few problems on account of the narrow spaces in which the operation may be performed.

Finally, boards of this type prove excessively flexible in the central part. The latter drawback is intrinsically not eliminable with an adequate design in so far as the element that renders the two parts fixed with respect to one another cannot have adequate transverse dimensions; otherwise, it would form protuberances that would hinder passage and sliding along the walls of the cave.

The patents Nos. US 2001/0044966, FR 2326911 and U.S. Pat. No. 5,765,243 describe stretchers that can be assembled or folded, which comprise elements that develop throughout the length of the stretcher itself. In this case, the stiffness and the flexural strength are ensured, but the length of the disassembled stretcher remains excessive, so that it is difficult to transport it through narrow spaces.

The purpose of the present invention is to overcome at least in part the drawbacks of the known art by proposing a dismantleable stretcher, in conformance with Claim 1, i.e., a stretcher of the type comprising a rigid part, or board, which can easily be dismantled and reassembled without the use of tools, said rigid part comprising elements that slot together to form said rigid board, designed to support the weight of the person to be carried, the stretcher being characterized in that it envisages at least one element that develops basically in a direction parallel to the longitudinal axis and connects up, by means of slotted joints, directly to the other elements constituting said board, in a way designed to bestow stiffness and flexural strength in the longitudinal direction of said board.

In order to reduce as far as possible the dimensions of the dismantled stretcher, the length of the various elements that make it up is an integer submultiple of the total length.

According to a preferred embodiment, the board can be broken down into five elements, four of which are symmetrical, in twos, with respect to the longitudinal axis and to the transverse axis, whilst the fifth, with basically longitudinal development, is in a central position and connects up simultaneously and directly with the other four, bestowing on the ensemble the necessary stiffness and flexural strength.

When the stretcher is thus dismantled, its length and width are approximately one half of the overall length and width of the assembled stretcher. Furthermore, given that the longitudinal element occupies a central position, it bestows the necessary stiffness and flexural strength upon the structure.

In order to slot the various elements that make up the board into one another, said elements perform a movement in a direction transverse to the longitudinal axis in the plane of the board itself. This means that simple straps designed to prevent the movement in the opposite direction are sufficient to keep the board in the assembled condition.

Other straps and belts, applied to the board, will enable the person being rescued to be secured to the stretcher itself, in a way not unlike what occurs with stretchers according to the known art.

In the case of cave rescues, the board according to the invention is used for stiffening the flexible container that is wound around the injured person, according to the same modalities used with assemblable boards of the known art described previously, without presenting the intrinsic faults thereof.

The invention is completed by a series of elements studied explicitly for the various types of use. These are in practice elements that are to be applied to the board and convert it into a stretcher suited for various types of rescue, such as gripping members necessary for the porters, elements for resting on the ground in the form of skis for winter mountain rescue and floats for rescue in water, in addition to straps and belts for harnessing for rescue with the use of helicopters.

The peculiar characteristic of the stretcher according to the invention is the fact that it can be easily dismantled and reassembled without the use of tools. Furthermore, since the stiffening board is made of composite material, preferably carbon, it is also very light and transparent to x-rays.

According to a preferred embodiment, the canvass part for the protection of the person rescued may be fixed in a stable way to the longitudinal edge of the board, without thereby limiting the possibility of dismantling it, in so far as the direction of the slotted joints is perpendicular to the longitudinal axis.

In addition to the advantages already recalled, which regard to lightness and the possibility of ease of dismantling and reassembly without the use of tools, the stretcher according to the invention is eminently suited to functioning as a support for the injured person, from the very moment in which the rescue is carried out until the person reaches the x-ray table in the hospital, practically ruling out altogether any need for manipulation that might prove extremely harmful in the presence of fractures and consequences of serious traumas.

For this purpose, it is sufficient to consider that at present for rescuing an injured skier it is necessary to harness him to a special stretcher suitable for sliding on the snow and then come down from the ski slopes, change the stretcher for transport on an ambulance or helicopter, transfer the injured person onto the bed in the hospital, and then onto the x-ray table.

With the use of the stretcher according to the invention, after the injured person has been harnessed to the stretcher itself, which is equipped for rescue operations on the snow, he will be transported from the ski slopes to the hospital for carrying out x-rays without making any transfer onto another stretchers or bed, hence remaining on the same stretcher also when the x-rays are being carried out. For this purpose, it will be sufficient to remove the accessories and leave just the rigid board. In this way, any discomfort due to the various displacements and any possible further damage linked to said operations are altogether avoided.

The invention will now be described, purely by way illustrative and non-limiting example, according to various preferred embodiments, with reference to the attached figures, in which:

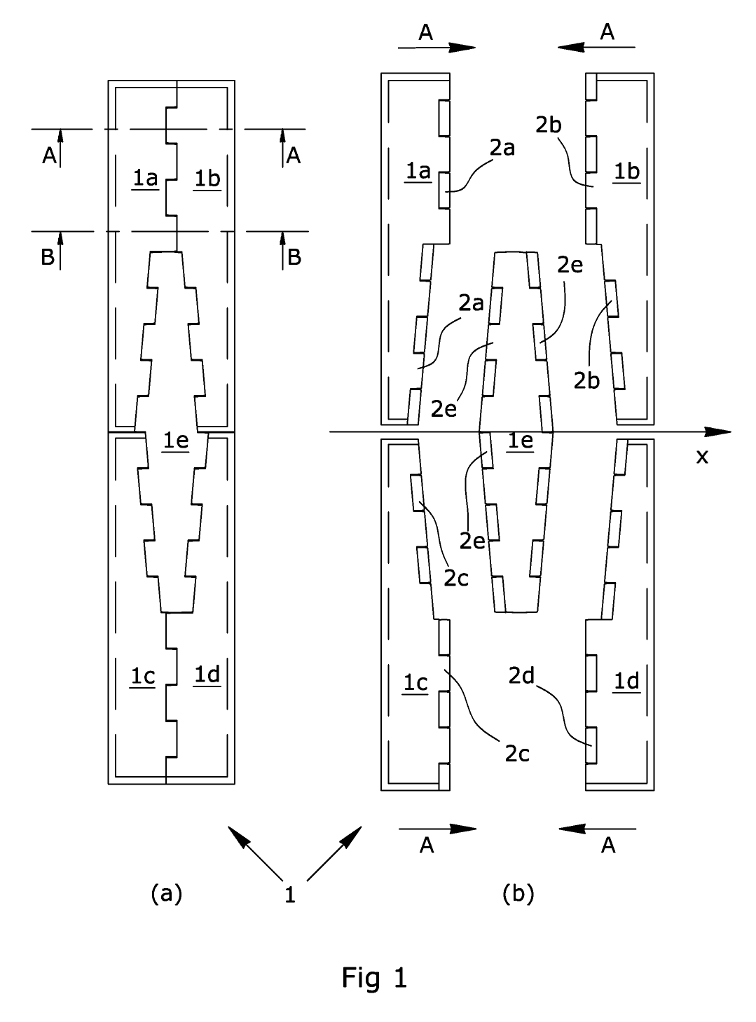

FIGS. 1 (a, b) show the stiffening board of the stretcher according to the invention;

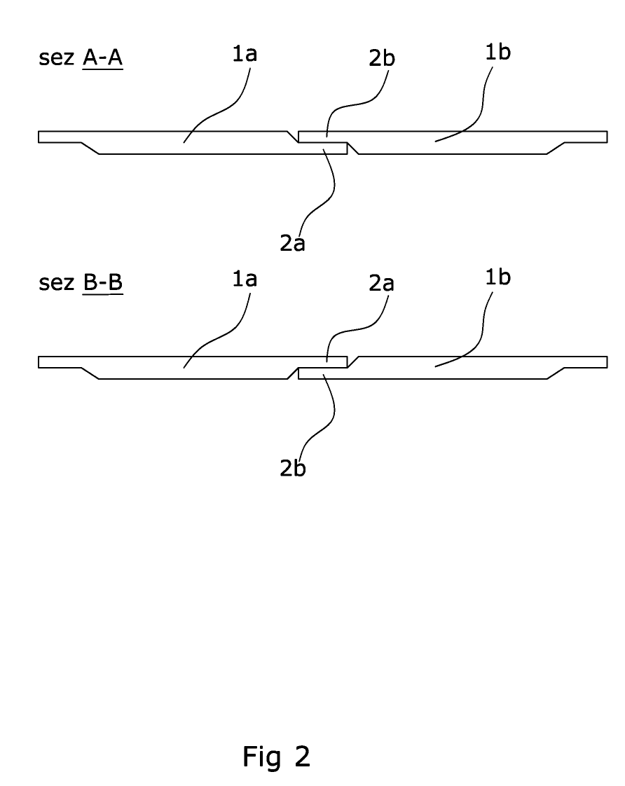

FIG. 2 shows in cross section the slotted joints that enable connection in a rigid way of the various parts that make up the rigid board;

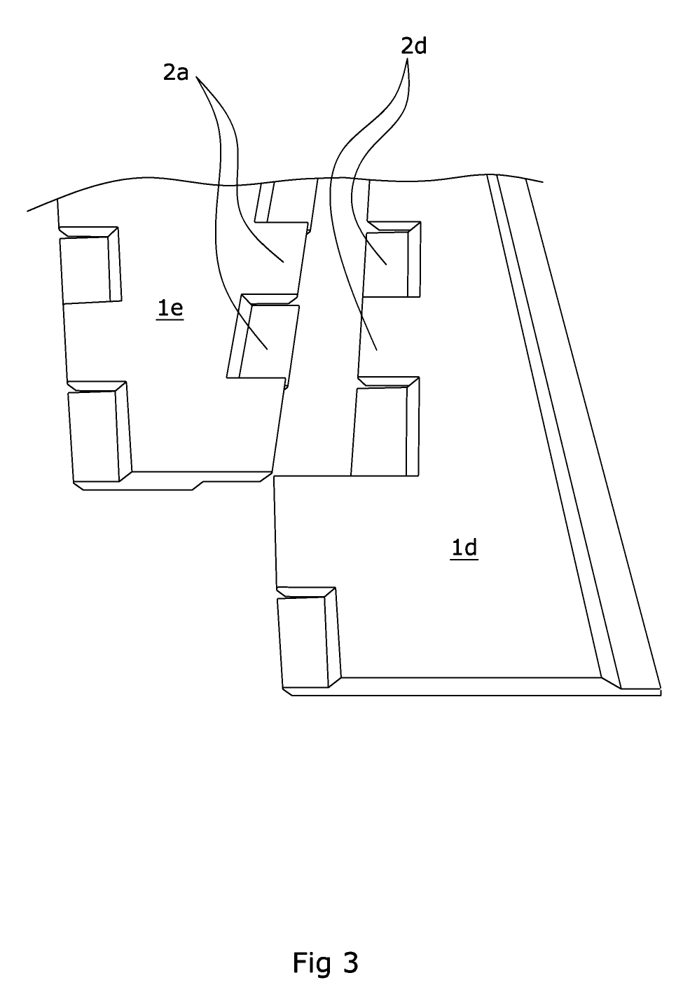

FIG. 3 shows in perspective view two parts that interface one another of the elements that make up the rigid board, with the corresponding slotted joints;

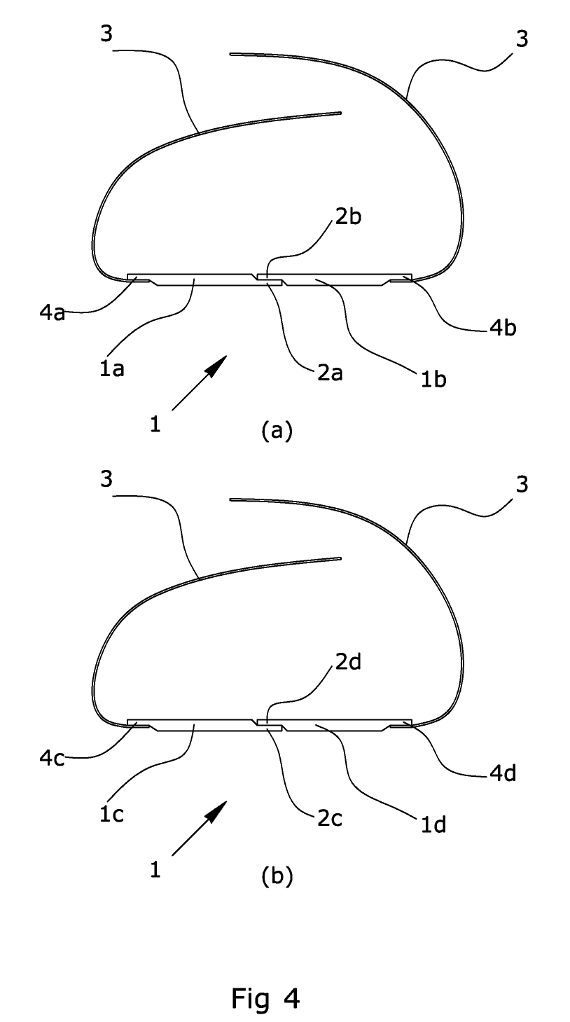

FIGS. 4 (a, b), 5, 6 and 7 show some arrangements of the stretcher for carrying out rescue operations in various situations.

With reference to FIGS. 1 (a, b), designated by (1) is a rigid board for supporting a stretcher according to the invention. In particular FIG. 1a shows the elements (1a, 1b, 1c, 1d, 1e) assembled, whilst FIG. 1b shows the same elements (1a, 1b, 1c, 1d, 1e) disassembled.

Said elements (1a, 1b, 1c, 1d, 1e) envisage the presence of slotting means (2a, 2b, 2c, 2d, 2e) on the edges, which, following upon assembly, will be set in contact, said slotting means (2a, 2b, 2c, 2d, 2e) being designed to block any relative movement that does not occur in a direction parallel to the axis “x”.

As emerges clearly, assembly is performed by carrying out a movement according to the arrows A, directed according to the axis “x”, bringing the slotted joints (2a) of the element (1a) to engage the corresponding slotted joints (2b) of the element (1b) and the corresponding slotted joints (2e) of the element (1e). Simultaneously, also the slotted joints (2e) of the element (1e) will engage the corresponding slotted joints (2b) of the element (1b).

Then, once again by carrying out a movement according to the arrows A, the slotted joints (2c) of the element (1c) are brought to engage the corresponding slotted joints (2d) of the element (1d) and the corresponding slotted joints (2e) of the element (1e). Also in this case, there will be a simultaneous engagement of slotted joints (2e) of the element (1e) with the corresponding slotted joints (2d) of the element (1d).

In this operation, the elements (1a) and (1b) will come into contact, respectively, with the elements (1c) and (1d), without there necessarily occurring a constraint between the facing elements (1a) and (1c), or else (1b) and (1d).

FIG. 2 shows the sections A-A and B-B indicated in FIG. 1. As may be clearly seen, the slotting means (2a) on the element (1a), constitute an alternating sequence of bottom “teeth” (sect. A-A) and top “teeth” (sect. B-B) along the edge that interfaces with the elements (1b) and (1e). Likewise, the slotting means (2b) on the element (1b), constitute an alternating sequence of top “teeth” (sect. A-A) and bottom “teeth” (sect. B-B) along the edge that interfaces with the elements (1a) and (1e). The same applies to each of the other elements (1c, 1d, 1e) in relation to the element that interfaces with each of them.

In FIG. 3 the slotted joints (2d) and (2e), corresponding to the elements (1d) and (1e), are shown in perspective view, from which there emerges with greater clarity of how the slotting between the elements in contact comes about.

From FIGS. 1, 2 and 3 it emerges clearly how constraints thus conceived enable the relative movement of the various elements only in a direction parallel to the axis “x” so that it is sufficient to prevent said movement in order to keep the board (1) assembled.

Said movement in a direction parallel to the axis “x” may be prevented, for example, with flexible straps (not represented) or rigid rods (not represented), or a combination of said straps and rigid rods, which constrain between them the elements that interface one another along the axis “x”, or else with pins (not represented) that are inserted in a direction transverse to the “teeth” that constitute the slotted joints, each of said pins penetrating simultaneously into both of the teeth in contact with one another.

As may be seen clearly in FIG. 1, the element (1e), which has an elongated shape and is located in the central part of the board (1), bestows thereon a considerable stiffness and flexural strength. It is basically a sort of splinting obtained with an element of considerable longitudinal and transverse dimensions, hence structurally extremely effective, which, however, thanks to the particular conformation described, including in particular the slotting means (2a, 2b, 2c, 2d, 2e), is completely inscribed within the general profile of the board (1). In this way, the high stiffness and flexural strength required is obtained, together with the total absence of protuberances.

In order to reduce as far as possible the dimensions of the dismantled stretcher, the length of the various elements (1a, 1b, 1c, 2d, 1e) that make it up is an integer submultiple of the total length. In the case illustrated in FIG. 1, the length of said elements (1a, 1b, 1c, 2d, 1e) is substantially equal to one half of the length of the assembled stretcher. With this choice the overall length is halved, with a contained number of elements.

The same applies to the width of said elements (1a, 1b, 1c, 2d, 1e).

Any person skilled in the sector will have no difficulty in providing a stretcher that can be broken down into a larger number of elements, thus obtaining a further reduction in the length and width of the dismantled stretcher, with the disadvantage, however, of an increase in the number of elements and the consequent increase both of the difficulties of transport and in the production costs.

As a consequence of the lengths chosen, the length of said element (1e), set in the central part of the board (1) is such that it engages the other four elements (1a, 1b, 1c, 1d) substantially for one half of their length.

The slotting means (2a, 2b, 2c, 2d, 2e) described are designed to prevent any relative movement that is not in a direction parallel to the axis “x”. However, constraints of this type constitute only the preferred, but non-exclusive, solution to the problem of assembly. In fact, connection means that enable relative sliding between the various elements constituting the board (1), albeit in the plane of the board itself, are suitable for the purpose. It will be sufficient for the fastening straps and/or the rigid rods to be mounted inclined in the two directions with respect to the axis “x”, for example at +45° and −45°. In other words, the slotting means have basically the job of preventing any relative rotations between the various elements that constitute the rigid board, whilst the relative translations can be eliminated also with other means.

The assemblable board (1) described can be used simply instead of the assemblable boards of the known art, i.e., for stiffening the harness normally used in cave rescues, or else for forming the central element of stretchers of various types, i.e., specialized according to the situations in which the rescue is carried out.

FIGS. 4 (a, b) show a possible variant of the use as simple stiffening element of the harness for cave rescue. As may be seen from the figures, the flexible part (3), which constitutes the harness, is fixed along the outer edges (4a) and (4b), of the element (1a) and of the element (1b), respectively (FIG. 4a). Said flexible harness (3) will of course be fixed also to the outer edges (4c) and (4d) of the elements (1c) and (1d) (FIG. 4b). Such a configuration does not limit the possibility of dismantling the board (1), because the relative mobility of the stiff elements of said board is not limited by the flexible parts (3) connected thereto, which can be easily folded back on one another.

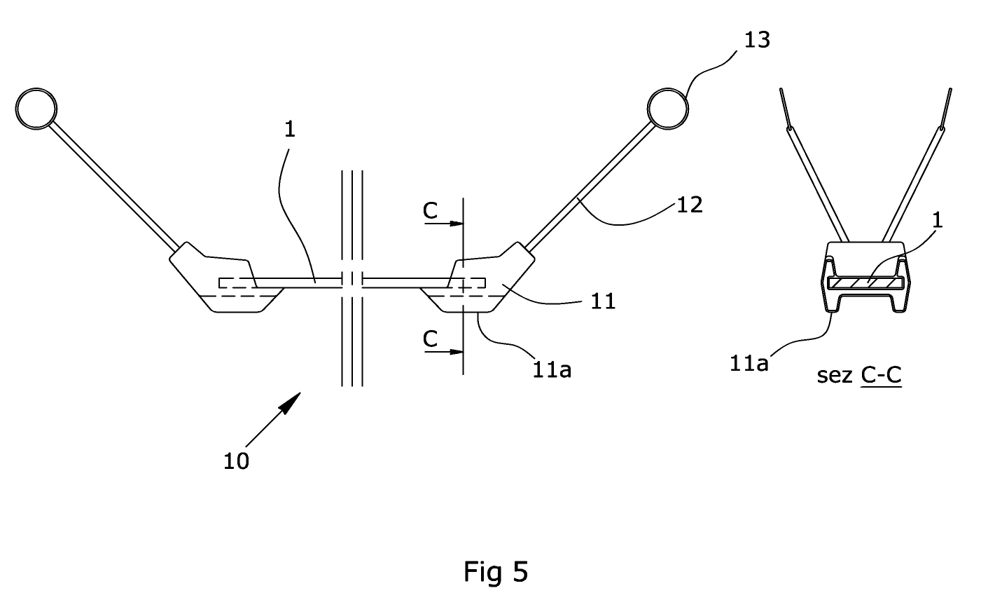

FIG. 5 shows a stretcher (10) for winter mountain rescue. Said stretcher (10) comprises an assemblable board (1) according to the invention, applied to which are terminal elements (11), designed, with the bottom part (11a), to slide on the snow, and to support each a pair of arms (12), with corresponding handles (13). Said terminal elements (11) can be dismantled in such a way that the injured person will be able to remain on the board (1) only. In this way, the board (1) may function as support for the injured person, enabling his transport by ambulance or helicopter to the hospital, where he may undergo the x-ray examinations, thus practically avoiding altogether any manipulation that might prove extremely harmful in the presence of fractures and consequences of serious traumas.

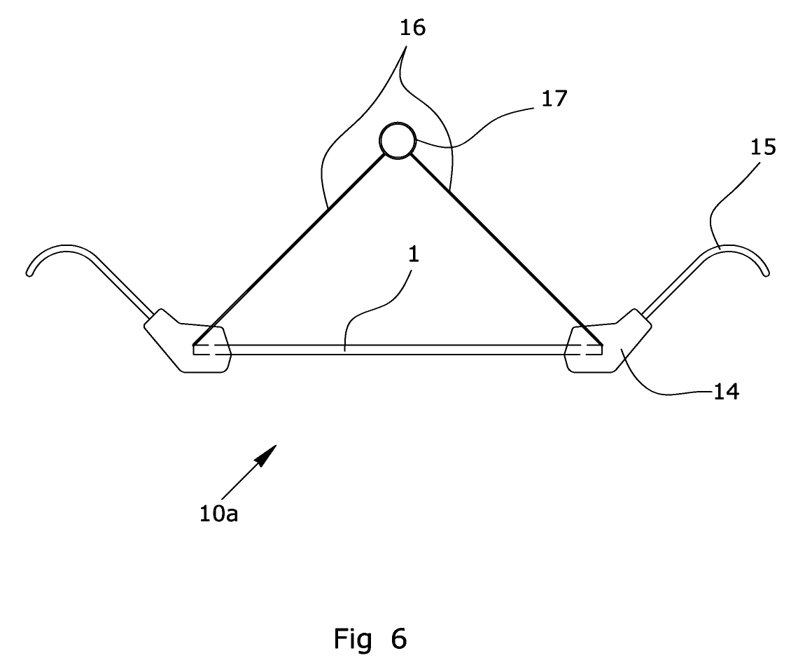

FIG. 6 shows a stretcher (10a) for generic rescue, equipped for being hoisted onto a helicopter. Said stretcher (10a) comprises an assemblable board (1) according to the invention, applied to which are terminal elements (14), designed to support each a pair of shoulder straps (15), a harness (16), and a ring (17), which enable engagement to a winch for being hoisted onto a helicopter. Also in this case, the terminals (14) can be removed.

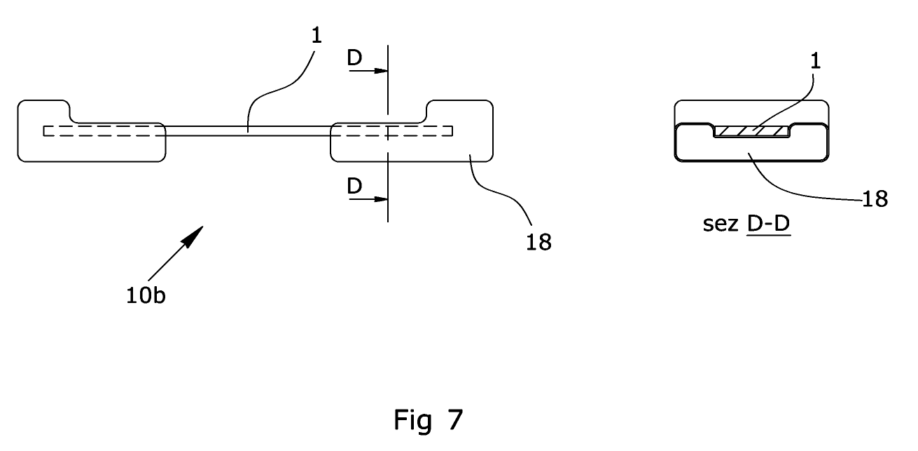

FIG. 7 shows a stretcher (10b) for rescue in water. Said stretcher (10b) comprises an assemblable board (1) according to the invention, applied to which are terminal elements (18) that constitute floats suitable for guaranteeing floating of the injured person being rescued.

The terminal elements (11), (14) and (18) can be advantageously obtained by rotational moulding. Said technology is suited in particular for providing floats (18), thanks to the ease with which it is possible to obtain hollow elements without any openings.

As emerges clearly from the foregoing description, the use of a stretcher according to the invention affords considerable advantages in terms of stiffness and strength, limited weight, and complete transparency to x-rays, with the consequent advantages in terms of movement of the injured person, as well as a greater practicality of use, above all considering its use in cave rescue, where the spaces in which the rescue staff is forced to operate may be particularly restricted.

The invention has been described by way of non-limiting illustration, according to some preferred embodiments. The person skilled in the sector may devise numerous other embodiments and variants, all of which fall within the sphere of protection of the ensuing claims.

1. A dismantleable stretcher, suitable for carrying out rescue of injured persons in impracticable or not easily accessible areas, as in the case of speleologists trapped in caves, people in difficulty in the mountains in summer or in winter, people to be rescued from the water, also with the intervention of helicopters, of the type comprising a rigid part, or board (1), which can easily be dismantled and reassembled without the use of tools, said rigid part comprising elements that slot together to form said rigid board (1), designed to support the weight of the person to be carried, said stretcher being characterized in that it envisages at least one element (1e) that develops basically in a direction parallel to the longitudinal axis of said board (1) and connects up directly to the other elements (1a, 1b, 1c, 1d) constituting said board (1), there being provided first means designed to prevent relative movements between said elements (1a, 1b, 1c, 1d, 1e) constituting said board (1), out of the plane of said board (1), and second means designed to prevent any relative sliding between said elements (1a, 1b, 1c, 1d, 1e), the length of said elements (1a, 1b, 1c, 2d, 1e) being substantially an integer submultiple of the total length of said stretcher (1).

2. The dismantleable stretcher according to claim 1, characterized in that the width of said elements (1a, 1b, 1c, 2d, 1e) is substantially equal to an integer submultiple of the total width of said stretcher (1).

3. The dismantleable stretcher according to claim 1, characterized in that the length of said elements (1a, 1b, 1c, 2d, 1e) is substantially equal to one half of the total width of said stretcher (1).

4. The dismantleable stretcher according to claim 2, characterized in that the width of said elements (1a, 1b, 1c, 2d, 1e) is substantially equal to one half of the total width of said stretcher (1).

5. The dismantleable stretcher according to claim 1, characterized in that said second means, designed to prevent any relative sliding between said elements (1a, 1b, 1c, 1d, 1e), comprise straps and/or rigid rods that connect together pairs of said elements (1a, 1b, 1c, 1d, 1e).

6. The dismantleable stretcher according to claim 5, characterized in that said straps and/or rods are set inclined in the two directions with respect to the longitudinal axis of said board (1).

7. The dismantleable stretcher according to claim 1, characterized in that said second means, designed to prevent any relative sliding between said elements (1a, 1b, 1c, 1d, 1e), comprise pins that fit simultaneously in the facing edges of said elements (1a, 1b, 1c, 1d, 1e) fitted together.

8. The dismantleable stretcher according to claim 1, characterized in that said first means, designed to prevent any relative movement between said elements (1a, 1b, 1c, 1d, 1e) constituting said board (1), out of the plane of said board (1), are slotted joints (2a, 2b, 2c, 2d, 2e) designed also to prevent any relative sliding between said elements (1a, 1b, 1c, 1d, 1e), except for the possible relative sliding in a direction transverse to the longitudinal axis of said board (1) in the plane of said board (1).

9. The dismantleable stretcher according to claim 1, characterized in that it envisages a flexible part (3), designed to harness the person being rescued so as to protect him when he is being carried, stably connected to said rigid board (1), said flexible part (3) being fixed along the outer edges (4a, 4b, 4c, 4d) of the elements (1a, 1b, 1c, 1d), respectively.

10. The dismantleable stretcher according to claim 1, characterized in that it envisages terminal elements (11) designed, with the bottom part (11a), to slide on the snow and to support each a pair of arms (12), with corresponding handles (13).

11. The dismantleable stretcher according to claim 1, characterized in that it envisages terminal elements (14) designed to support each a pair of shoulder straps (15).

12. The dismantleable stretcher according to claim 1, characterized in that it envisages terminal elements (18) that constitute floats suitable for guaranteeing floating of the injured person being rescued.

13. The dismantleable stretcher according to claim 7, characterized in that it envisages a harness (16) and a ring (17) designed to enable engagement to a winch for being hoisted onto a helicopter.

14. The dismantleable stretcher according to claim 7, characterized in that said terminal elements (11), (14) and (18) are obtained by means of rotational moulding.
